(19) United States
(12) Patent Application Publication
(10) Pub. No.: US 2007/0074217 A1
(43) Pub. Date: Mar. 29, 2007

(54) Scheduling optimizations for user-level threads

(76) Inventors: Ryan Rakvic, Palo Alto, CA (US); Richard A. Hankins, Santa Clara, CA (US); Hong Wang, Santa Clara, CA (US); Trung Diep, San Jose, CA (US); Xinmin Tain, Santa Clara, CA (US); Paul Petersen, Champaign, IL (US); Sanjiv Shah, Portland, OR (US); John Shen, San Jose, CA (US); Gautham N. Chinya, Hillsboro, OR (US); Shivnandan Kaushik, Portland, OR (US); Bryant Bigbee, Scottsdale, AZ (US); Baiju V. Patel, Portland, OR (US); Douglas R. Armstrong, Champaign, IL (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/235,865

(22) Filed: Sep. 26, 2005

(51) Int. Cl. G06F 9/46

(52) U.S. Cl. 718/102

(57) ABSTRACT

Method, apparatus and system embodiments to schedule user-level OS-independent “shreds” without intervention of an operating system. For at least one embodiment, the shred is scheduled for execution by a scheduler routine rather than the operating system. The scheduler routine resides in user space and may be part of a runtime library. The library may also include monitoring logic that monitors execution of a shredded program and provides scheduling hints, based on shred dependence information, to the scheduler. In addition, the scheduler may further optimize shred scheduling by taking into account information about a system's configuration of thread execution hardware. Other embodiments are also described and claimed.

### BACKGROUND

1. Technical Field

The present disclosure relates generally to information processing systems and, more specifically, to improved efficiency for self-scheduling of user-level threads that are not scheduled by an operating system.

2. Background Art

In order to increase performance of information processing systems, such as those that include microprocessors, both hardware and software techniques have been employed. On the hardware side, microprocessor design approaches to improve microprocessor performance have included increased clock speeds, pipelining, branch prediction, super-scalar execution, out-of-order execution, and caches. Many such approaches have led to increased transistor count, and have even, in some instances, resulted in transistor count increasing at a rate greater than the rate of improved performance.

Rather than seek to increase performance strictly through additional transistors, other performance enhancements involve software techniques. One software approach that has been employed to improve processor performance is known as “multithreading.” In software multithreading, an instruction stream may be divided into multiple instruction streams that can be executed in parallel. Alternatively, multiple independent software streams may be executed in parallel.

In one approach, known as time-slice multithreading or time-multiplex (“TMUX”) multithreading, a single processor switches between threads after a fixed period of time. In still another approach, a single processor switches between threads upon occurrence of a trigger event, such as a long latency cache miss. In this latter approach, known as switch-on-event multithreading (“SoEMT”), only one thread, at most, is active at a given time.

Increasingly, multithreading is supported in hardware. For instance, in one approach, processors in a multi-processor system, such as a chip multiprocessor (“CMP”) system, may each act on one of the multiple software threads concurrently. In another approach, referred to as simultaneous multithreading (“SMT”), a single physical processor is made to appear as multiple logical processors to operating systems and user programs. For SMT, multiple software threads can be active and execute simultaneously on the single physical processor without switching. That is, each logical processor maintains a complete set of the architecture state, but many other resources of the physical processor, such as caches, execution units, branch predictors, control logic and buses are shared. For SMT, the instructions from multiple software threads each on a distinct logical processor, execute concurrently.

For a system that supports concurrent execution of software threads, such as SMT and/or CMP systems, an operating system application may control scheduling and execution of the software threads. Typically, however, operating system control does not scale well; the ability of an operating system application to schedule threads without negatively impacting performance is commonly limited to a relatively small number of threads.

### BRIEF DESCRIPTION OF THE DRAWINGS

Embodiments of the present invention may be understood with reference to the following drawings in which like elements are indicated by like numbers. These drawings are not intended to be limiting but are instead provided to illustrate selected embodiments of an apparatus, system and method to judiciously schedule user-level threads in a multithreaded system.

FIG. 1 is a block diagram presenting a graphic representation of a general parallel programming approach for a multi-sequencer system.

FIG. 2 is a block diagram illustrating shared memory and state among threads and shreds for at least one embodiment of user-level multithreading.

FIG. 3 is a block diagram illustrating various embodiments of multi-sequencer systems.

FIG. 4 is a data flow diagram illustrating at least one embodiment of a scheduling mechanism for a multi-sequencer multithreading system that supports user-level shreds.

FIG. 5 is a block diagram illustrating at least one embodiment of a software runtime library.

FIG. 6 is a data flow diagram illustrating at least one embodiment of a software runtime library capable of generating scheduling hints for user-level threads.

FIG. 7 is a directed graph illustrating at least one embodiment of an example shred dependency graph.

FIG. 8 is a directed graph illustrating at least one embodiment of a time-stamped shred dependency graph.

FIG. 9 is a flowchart illustrating at least one embodiment of a method for generation of scheduling hints.

FIG. 10 is a block diagram illustrating at least one embodiment of a system capable of performing disclosed techniques.

FIG. 11 is a data flow diagram illustrating a data migration optimization approach.

### DETAILED DESCRIPTION

The following discussion describes selected embodiments of methods, systems and articles of manufacture to improve efficiency of scheduling for multiple concurrently-executed user-level threads of execution (referred to as “shreds”) that are not created or scheduled by the operating system. The shreds are instead scheduled by a feedback-driven scheduler that can dynamically adapt shred scheduling based on runtime feedback and prediction of inter-shred correlations.

The shreds may be scheduled to run on one or more OS-sequestered sequencers. The OS-sequestered sequencers are sometimes referred to herein as “OS-invisible”; the operating system does not schedule work on such sequencers. The mechanisms described herein may be utilized with single-core or multi-core multithreading systems. In the following description, numerous specific details such as processor types, multithreading environments, system configurations, and numbers and topology of sequencers in a multi-sequencer system have been set forth to provide a more thorough understanding of the present invention. It will be appreciated, however, by one skilled in the art that the invention may be practiced without such specific details. Additionally, some well known structures, circuits, and the like have not been shown in detail to avoid unnecessarily obscuring the present invention.

A shared-memory multiprocessing paradigm may be used in an approach referred to as parallel programming. According to this approach, an application programmer may split a software program, sometimes referred to as an “application” or “process,” into multiple tasks to be run concurrently in order to express parallelism for a software program. All threads of the same software program (“process”) share a common logical view of memory.

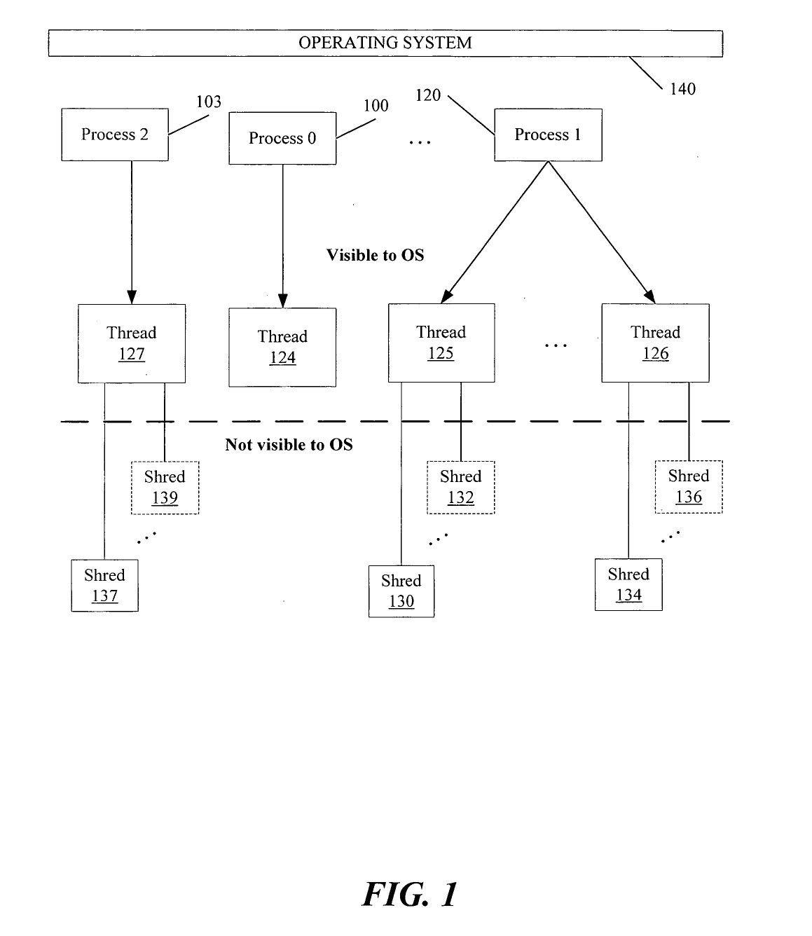

FIG. 1 is a block diagram illustrating a graphic representation of a parallel programming approach on a multi-sequencer multithreading system. FIG. 1 illustrates processes 100, 103, 120 that are visible to an operating system (“OS”) 140. These processes 100, 103, 120 may be different software application programs, such as, for example, a word processing program, a graphics program, and an email management program. Commonly, each process operates in a different virtual address space.

The operating system (“OS”) 140 is commonly responsible for managing the user-defined tasks for a process (e.g., processes 103 and 120). While each process has at least one task (see, e.g., process 0 100 and process 2 103), others may have more than one (e.g., Process 1 120) such tasks. The number of processes illustrated in FIG. 1, as well as the number of user-defined tasks for each process, should not be taken to be limiting. Such illustration is for explanatory purposes only.

FIG. 1 illustrates a distinct thread 125, 126 for each of the user-defined tasks associated with a process 120 may be created in operating system 140, and the operating system 140 may map the threads 125, 126 to thread execution resources. (Thread execution resources are not shown in FIG. 1, but are discussed in detail below.) Similarly, a thread 127 for the user-defined task associated with process 103 may be created in the operating system 140; so may a thread 124 for the user-defmed task associated with process 0.

The OS 140 is commonly responsible for scheduling these threads 125, 126, 127 for execution on the execution resources. The threads associated with the same process typically have the same virtual memory address space.

Because the OS 140 is responsible for creating, mapping, and scheduling threads, the threads 125, 126, 127 are “visible” to the OS 140. In addition, embodiments of the present invention comprehend additional threads 130-139 that are not visible to the OS 140. That is, the OS 140 does not create, manage, or otherwise acknowledge or control these additional threads 130-139. These additional threads, which are neither created nor controlled by the OS 140, are sometimes referred to herein as “shreds” 130-139 in order to distinguish them from OS-visible threads. The shreds are created and managed by user-level programs (referred to as “shredded programs”) and may be scheduled to run on sequencers that are sequestered from the operating system. The OS-sequestered sequencers typically share a common set of ring 0 states as OS-visible sequencers. These shared ring-0 architectural states are typically those responsible for supporting a common shared memory address space between the OS-visible sequencer and OS-sequestered sequencers. For example, for an embodiment based on IA-32 architecture, CR0, CR2, CR3, CR4 are some of these shared ring-0 architectural states. Shreds thus share the same execution environment (virtual address map) that is created for the threads associated with the same process.

As used herein, the terms “thread” and “shred” include, at least, the concept of a set of instructions to be executed concurrently with other threads and/or shreds of a process. The thread and “shred” terms both encompass the idea, therefore, of a set of software primitives or application programming interfaces (API). As used herein, a distinguishing factor between a thread (which is OS-controlled) and a shred (which is not visible to the operating system and is instead user-controlled), which are both instruction streams, lies in the difference of how scheduling and execution of the respective thread and shred instruction streams are managed. A thread is generated in response to a system call to the OS. The OS generates that thread and allocates resources to run the thread. Such resources allocated for a thread may include data structures that the operating system uses to control and schedule the threads.

In contrast, at least one embodiment of a shred is generated via a user level software “primitive” that invokes an OS-independent mechanism for generating a shred that the OS is not aware of. A shred may thus be generated in response to a user-level software call. For at least one embodiment, the user-level software primitives may involve user-level (ring-3) instructions that can create a user-level shred in hardware or firmware. The user-level shred thus created may be scheduled by hardware and/or firmware and/or user-level software. The OS-independent mechanism may be software code that sits in user space, such as a software library. The techniques for shred scheduling optimizations discussed herein may be used with any user-level thread package.

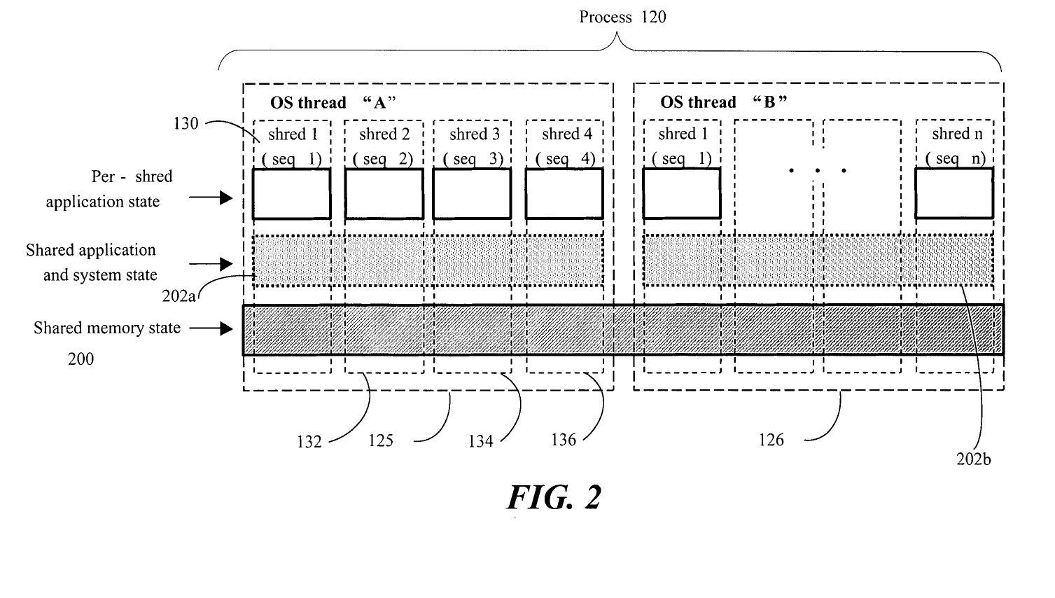

FIG. 2 is a block diagram illustrating, in graphical form, further detail regarding the statement, made above, that all threads of the same software program or process share a common logical view of memory. This common logical view of memory that is associated with all threads for a program or process may be referred to herein as an “application image.” For embodiments of the present invention, this application program image is also shared by shreds associated with a process 100, 103, 120 (FIG. 1). FIG. 2 is discussed herein with reference to FIG. 1.

FIG. 2 depicts the graphical representation of a process 120, threads 124, 125, 126 and shreds 130-136 illustrated in FIG. 1. However, such representation should not be taken to be limiting. Embodiments of the present invention do not necessarily impose an upper or lower bound on the number of threads or shreds associated with a process. Regarding a lower bound, FIG. 1 illustrates that every process running at a given time is associated with at least one thread. However, the threads need not necessarily be associated with any shreds at all. For example, Process 0 100 illustrated in FIG. 1 is shown to run with one thread 124 but without any shreds at the particular time illustrated in FIG. 1.

However, other processes 103, 120 may be associated with one or more OS-scheduled threads as illustrated in FIG. 1. Dotted lines and ellipses are used in FIG. 1 to represent optional additional shreds. FIG. 1 illustrates one process 103 associated with one OS-scheduled thread 127 and also illustrates another process 120 associated with two or more threads 125-126. In addition, each process 103, 120 may additionally be associated with one or more shreds 137-139, 130-136, respectively. The representation of two threads 125, 126 and four shreds 130-136 for Process 1 120 and of one thread 127 and two shreds 137, 139 for Process 2 103 is illustrative only and should not be taken to be limiting. The number of OS-visible threads associated with a process may be limited by the OS program. However, the upper bound for the cumulative number of shreds associated with a process is limited, for at least one embodiment, only by the amount of algorithmic thread level parallelism and the number of shred execution resources (e.g. number of sequencers) available at a particular time during execution.

FIG. 2 illustrates that a second thread 126 associated with a process 120 may have a different number (n) of threads associated with it than the first thread 125. (N may be 0 for either or both of the threads 125, 126.)

illustrates that a particular logical view 200 of memory is shared by all threads 125, 126 associated with a particular process 120. FIG. 2 illustrates that each thread 125, 126 has its own application and system state 202a, 202b, respectively. FIG. 2 illustrates that the application and system state 202 for a thread 125, 126 is shared by all shreds (for example, shreds 130-136) associated with the particular thread. For at least one embodiment, for example, all shreds associated with a particular shred may share the ring 0 states and at least a portion of the application states associated with the particular thread.

Accordingly, FIG. 2 illustrates that a system for at least one embodiment of the present invention may support a 1-to-many relationship between an OS-visible thread, such as thread 125, and the shreds 130-132 (which are not visible to the OS) associated with the thread. The shreds are not “visible” to the OS (see 140, FIG. 1) in the sense that a programmer, not the OS, may employ user-level techniques to create, synchronize and otherwise manage and control operation of the shreds. While the OS 140 is aware of, and manages, one or more threads, the OS 140 is not aware of, and does not manage or control, shreds.

Thus, instead of relying on the operating system to manage the mapping between thread unit hardware and shreds, scheduler logic in user space may manage the mapping. For at least one embodiment, the scheduler logic may be in a runtime software library.

For at least one embodiment a user may directly control such mapping by utilizing shred control instructions or primitives that are handled by the scheduler or other logic in software, such as in a runtime library. In addition, the user may directly manipulate control and state transfers associated with shred execution. Accordingly, for embodiments of the methods, mechanisms, articles of manufacture, and systems described herein, a user-visible feature of the architecture of the thread units is at least a canonical set of instructions that allow a user direct manipulation and control of thread unit hardware.

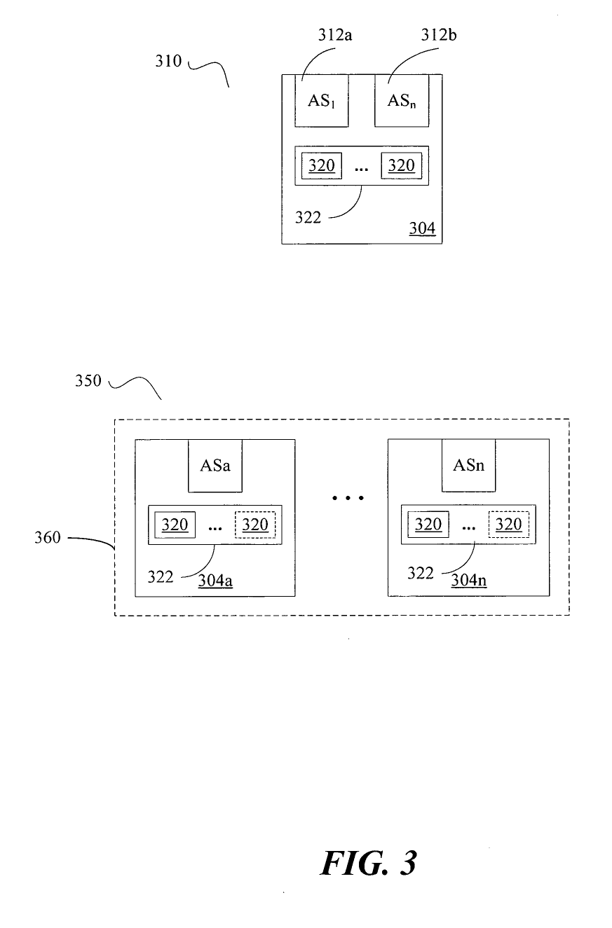

As used herein, a thread unit, also interchangeably referred to herein as a “sequencer”, may be any physical or logical unit capable of executing a thread or shred. It may include next instruction pointer logic to determine the next instruction to be executed for the given thread or shred. For example, the OS thread 125 illustrated in FIG. 1 may execute on a sequencer, not shown, as “Thread A” 125 in FIG. 2, while each of the active shreds 130-136 may execute on other sequencers, “seq 1”-“seq 4”, respectively. A sequencer may be a logical thread unit or a physical thread unit. Such distinction between logical and physical thread units is illustrated in FIG. 3.

FIG. 3 is a block diagram illustrating selected hardware features of embodiments 310, 350 of a multi-sequencer system capable of performing disclosed techniques. FIG. 3 illustrates selected hardware features of a single-core multi-sequencer multithreading environment 310. FIG. 3 also illustrates selected hardware features of a multiple-core multithreading environment 350, where each sequencer is a separate physical processor core.

In the single-core multithreading environment 310, a single physical processor 304 is made to appear as multiple logical processors (not shown), referred to herein as LP₁ through LPₙ, to operating systems and user programs. Each logical processor LP₁ through LPₙ maintains a complete set of the architecture state AS₁-ASₙ, respectively. The architecture state includes, for at least one embodiment, data registers, segment registers, control registers, debug registers, and most of the model specific registers. The logical processors LP₁-LPₙ share most other resources of the physical processor 304, such as caches, execution units, branch predictors, control logic and buses. Although such features may be shared, each thread context in the multithreading environment 310 can independently generate the next instruction address (and perform, for instance, a fetch from an instruction cache, an execution instruction cache, or trace cache). Thus, the processor 304 includes logically independent next-instruction-pointer and fetch logic 320 to fetch instructions for each thread context, even though the multiple logical sequencers may be implemented in a single physical fetch/decode unit 322. For a single-core multithreading embodiment, the term “sequencer” encompasses at least the next-instruction-pointer and fetch logic 320 for a thread context, along with at least some of the associated architecture state, 312, for that thread context. It should be noted that the sequencers of a single-core multithreading system 310 need not be symmetric. For example, two single-core multithreading sequencers for the same physical core may differ in the amount of architectural state information that they each maintain.

A single-core multithreading system can implement any of various multithreading schemes, including simultaneous multithreading (SMT), switch-on-event multithreading (SoeMT) and/or time multiplexing multithreading (TMUX). When instructions from more than one hardware thread contexts (or logical processor) run in the processor concurrently at any particular point in time, it is referred to as SMT. Otherwise, a single-core multithreading system may implement SoeMT, where the processor pipeline is multiplexed between multiple hardware thread contexts, but at any given time, only instructions from one hardware thread context may execute in the pipeline. For SoeMT, if the thread switch event is time based, then it is TMUX.

Thus, for at least one embodiment, the multi-sequencer system 310 is a single-core processor 304 that supports concurrent multithreading. For such embodiment, each sequencer is a logical processor having its own instruction next-instruction-pointer and fetch logic and its own architectural state information, although the same physical processor core 304 executes all thread instructions. For such embodiment, the logical processor maintains its own version of the architecture state, although execution resources of the single processor core may be shared among concurrently-executing threads.

FIG. 3 also illustrates at least one embodiment of a multi-core multithreading environment 350. Such an environment 350 includes two or more separate physical processors 304a-304n that is each capable of executing a different thread/shred such that execution of at least portions of the different threads/shreds may be ongoing at the same time. Each processor 304a through 304n includes a physically independent fetch unit 322 to fetch instruction information for its respective thread or shred. In an embodiment where each processor 304a-304n executes a single thread/shred, the fetch/decode unit 322 implements a single next-instruction-pointer and fetch logic 320. However, in an embodiment where each processor 304a-304n supports multiple thread contexts, the fetch/decode unit 322 implements distinct next-instruction-pointer and fetch logic 320 for each supported thread context. The optional nature of additional next-instruction-pointer and fetch logic 320 in a multiprocessor environment 350 is denoted by dotted lines in FIG. 3.

For at least one embodiment of the multi-core system 350 illustrated in FIG. 3, each of the sequencers may be a processor core 304, with the multiple cores 304a-304n residing in a single chip package 360. Each core 304a-304n may be either a single-threaded or multi-threaded processor core. The chip package 360 is denoted with a broken line in FIG. 3 to indicate that the illustrated single-chip embodiment of a multi-core system 350 is illustrative only. For other embodiments, processor cores of a multi-core system may reside on separate chips. That is, the multi-core system may be a multi-socket symmetric multiprocessing system.

For ease of discussion, the following discussion focuses on embodiments of the multi-core system 350. However, this focus should not be taken to be limiting, in that the mechanisms described below may be performed in either a multi-core or single-core multi-sequencer environment.

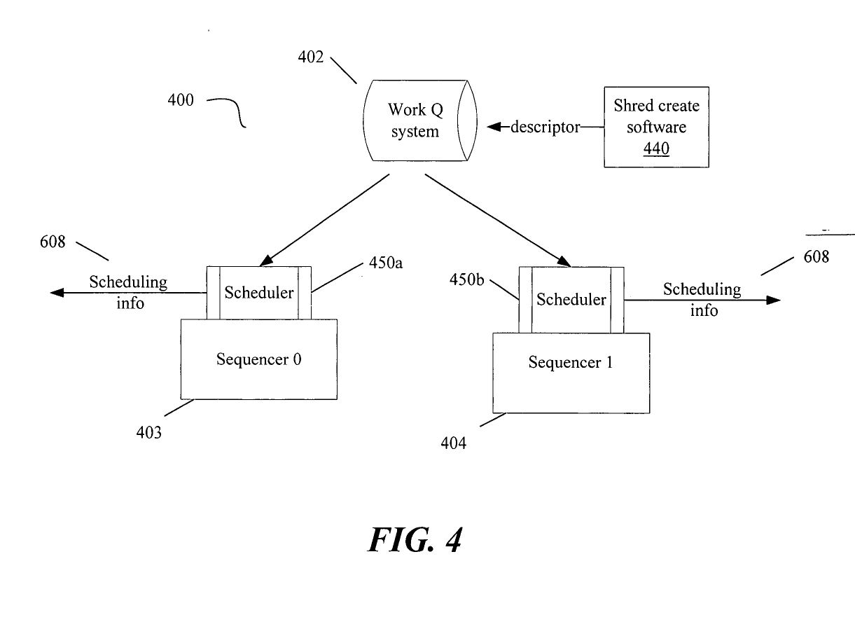

FIG. 4 is a data flow diagram illustrating at least one embodiment of a scheduling mechanism 400 for a multi-sequencer multithreading system that supports user-level thread control. The mechanism 400 includes a scheduler routine 450, which may execute on each of multiple sequencers 403, 404. Of course, the illustration of only two sequencers in FIG. 4 is for illustrative purposes only. One of skill in the art will recognize that a system may include more than two sequencers, which may be all of a single sequencer type (symmetric) or may each be one of multiple sequencer types (asymmetric).

FIG. 4 illustrates that the mechanism 400 includes a work queue system 402. The work queue system 402 may include one or more queues to maintain, for at least one embodiment, descriptors for user-defined shreds that are in line for execution and are therefore “pending”. One or more queues may be utilized to hold descriptors for shreds that are waiting for a shared resource to become available, such as a synchronization object or a sequencer. The work queue system 402, as well as the scheduler logic 450, may be implemented as software. In alternative embodiments, however, the queue system 402 and scheduler logic 450 may be implemented in hardware or may be implemented as firmware (such as micro-code in a read-only memory).

As is stated above, the scheduling mechanism 400 may be employed rather than an OS-provided scheduling mechanism. Each work descriptor describes a shred that is to be executed, independent of OS intervention, on either an OS-sequestered or OS-visible sequencer.

Shred descriptors may be created in response to user-level shred creation instructions (or “primitives”) executed by another shred or by a shred-aware thread. The descriptors may be placed into the work queue system 402. For at least one embodiment, the user-level instructions that trigger creation of shred descriptors are API-like (“Application Programmer Interface”) thread control primitives such as “shred_create” or “shred_fork”.

As used herein, an instruction or primitive described as being generated by a programmer or user is intended to encompass not only architectural instructions that may generated by an assembler or compiler based on user-generated code, or by a programmer working in an assembly language, but also any high-level primitive or instruction that may ultimately be assembled or compiled into architectural shred control instructions. It should also be understood that an architectural shred control instruction may be further decoded into one or more micro-operations.

One of skill in the art will recognize that there may be one or more levels of abstraction between the programmer's code (e.g., code that includes an API-like shred_create primitive) and actual architectural instructions that cause a sequencer to perform actions resulting in the generation of shred descriptors and placement of the descriptors into a work queue 402. Software 440, such as that provided by a software runtime library, may create, responsive to a shred_create primitive, a shred descriptor for the new shred and may place it into the work queue system 402.

For at least one embodiment, then, a shred descriptor is thus created by software 440 responsive to a shred_create primitive and is placed into the queue system 402. The shred descriptor may be, for at least one embodiment, a record that identifies at least the following properties for a shred: a) the address at which the shred should begin execution and b) a stack descriptor. The stack descriptor identifies the memory storage area (stack) to be used by the new shred to store temporary variables, such as local variables and return addresses.

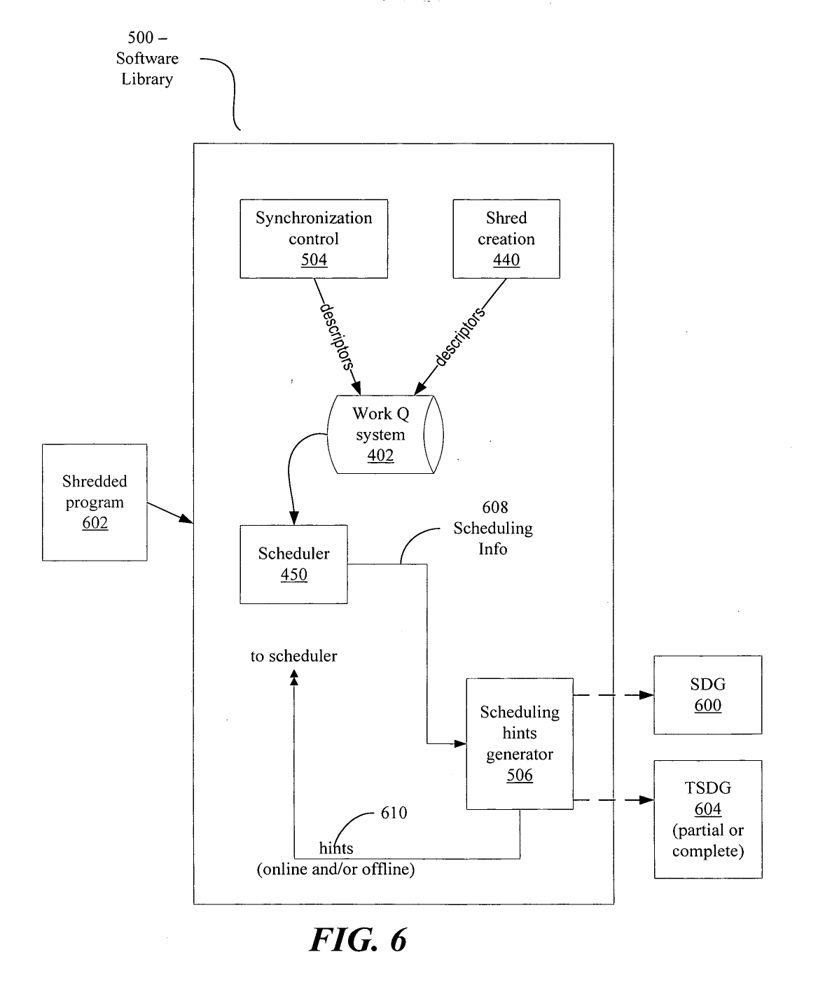

FIG. 4 further illustrates that the scheduler routine 450a, 450b for each of the sequencers may access the work queue system 402 in order to obtain a shred for execution on the associated sequencer 403, 404. When the scheduler routines 450a, 450b schedule shreds, they may provide information regarding the scheduling instance so that the instance may be recorded (see discussion, below, FIG. 6). For at least one embodiment, the scheduling information 608 provided by the scheduler 450a, 450b may include a shred ID for the shred being scheduled, along with other ancillary information such as a time stamp.

It should be noted that the sequencers 403, 404 illustrated in FIG. 4 need not be symmetric, and the number of sequencers illustrated in FIG. 4 should not be taken to be limiting. Regarding the number of sequencers, the scheduling mechanism 400 may be utilized for any number of sequencers. For example, and without limitation, the scheduling mechanism may be implemented for a multi-sequencer system that includes four, eight, sixteen, thirty-two or more sequencers.

Regarding symmetry, FIG. 4 illustrates a scheduling mechanism 400 for a system that may include at least two types of asymmetric sequencers—Type A sequencers 403 and Type B sequencers 404. Each sequencer 403, 404 includes or runs a portion of a distributed scheduler routine 450. The portions 450a, 450b may be identical copies of each other, but need not necessarily be so.

The sequencers 403, 404 may differ in any manner, including those aspects that affect quality of computation. For example, the sequencers may differ in terms of power consumption, thermal metrics, speed of computational performance, finctional features, microarchitectural organization, architectural features, or the like. By way of example, for one embodiment, the sequencers 403, 404 may differ in terms of functionality. For example, one sequencer may be capable of executing integer and floating point instructions, but cannot execute a single instruction multiple data (“SIMD”) set of instruction extensions, such as Streaming SIMD Extensions 3 (“SSE3”). On the other hand, another sequencer may be capable of performing all the instructions that the first sequencer can execute, and can also execute SSE3 instructions.

As another example of functional asymmetry, one sequencer 403 may be visible to the OS (see, for example, 140 of FIG. 1) and may therefore be capable of performing supervisor mode (e.g., “ring 0” for IA32) operations such as performing system calls, servicing a page fault, and the like. On the other hand, another sequencer 404 may be sequestered from the OS, and therefore be capable of only user-level (e.g.,“ring-3” for IA32) operations and incapable of performing ring 0 operations.

The sequencers of a system on which the scheduling mechanism 400 is utilized may also differ in any other manner, such as footprint, word width and/or data path size, topology, memory, power consumption, number of functional units, communication architectures (multi-drop vs. point-to-point interconnect), or any other metric related to functionality, performance, footprint, or the like.

For at least one embodiment, the functionality of type A and type B sequencers may be mutually exclusive. That is, for example, one type of sequencer 403 may support a particular functionality, such as execution of SSE3 instructions, that the other type of sequencer 404 does not support; while the second type of sequencer 404 may support a particular functionality, such as ring 0 operations, that the first type of sequencer 403 does not support.

However, for at least one other embodiment, the functionality of sequencer types A 403 and B 404 represent a superset-subset functionality relationship rather than a mutually exclusive functionality relationship. That is, a first set of sequencers (such as type A sequencers 403) provide a superset of functionality that includes all functionality of a second set of sequencers (such as type B sequencers 404), plus additional functionality that is not provided by the second set of sequencers 404.

For at least some embodiments of the mechanisms, systems, and methods described herein, a distributed scheduler 450 operates as an event-driven self-scheduler where shreds are created in response to queued scheduling events that are created as a result of API-like shred control (e.g., shred_create, shred_fork and/or the like) or shred synchronization (e.g., shred_yield, mutex (shred_lock/shred_unlock), critical section, and/or the like) instructions or primitives.

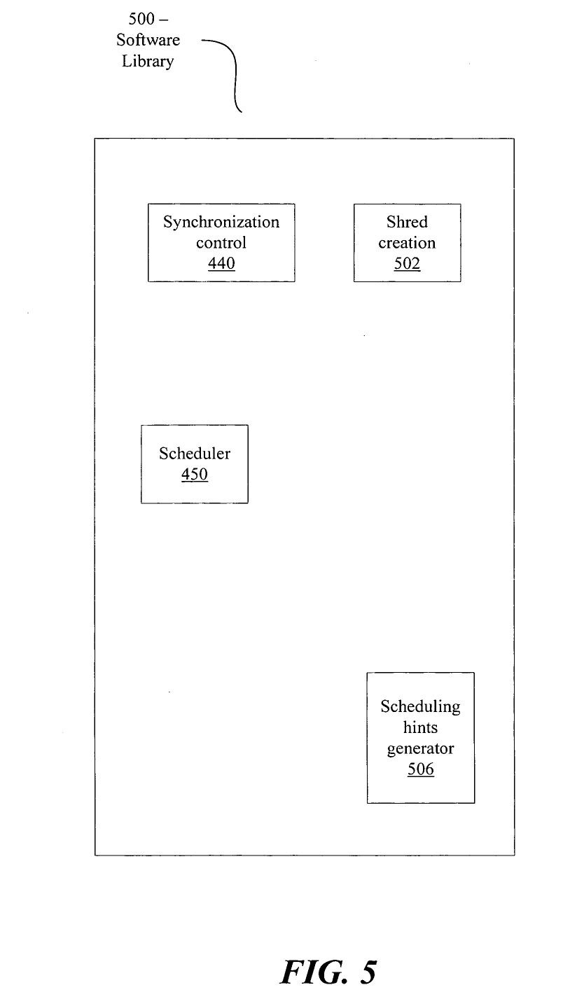

FIG. 5 is a block diagram illustrating at least one embodiment of run-time software 500. The embodiment of the software 500 shown in FIG. 5 is a software library, but such illustration should not be taken to be limiting. The features illustrated in FIG. 5 may reside anywhere in user space. The software library 500 may include a scheduler 450 as discussed above. The software library 500 may also include shred creation software 440 that creates a shred descriptor in response to a “create” API-like user instruction such as, for example, “shred_create”. As is discussed above, the shred creation software 440 may provide for creation of a shred by placing a shred descriptor into a work queue system (see, e.g., 402 of FIG. 4).

In addition, the software library 500 may also include shred synchronization control software 504. The shred synchronization control software 504 may perform shred synchronization functions in response to a shred synchronization user-level primitive, such as a yield primitive or a shred mutex or critical section primitive.

If a “yield” primitive is encountered in the current shred, a shred descriptor for the calling process may be placed back into the queue system and control returned to the scheduler 450. Accordingly, upon execution of a “yield” primitive, the synchronization control software 504 may place a shred descriptor for the remaining shred instructions for the current shred back into the work queue system 402 (FIG. 4).

In addition, the software library 500 may also include a scheduling hints generator 506. The scheduling hints generator 506 may create a shred dependency graph (SDG) and/or time-stamped shred dependency graph (TSDG), discussed in further detail below.

FIG. 5 illustrates that any or all of the shred scheduler 450, shred creation/termination software 440, shred synchronization control software 504 and scheduling hints generator 506 may be implemented as part of the run-time library 500. Although illustrated herein as software logic, one of skill in the art will recognize that the finctional of the library 500 may be implemented as firmware, as a combination of firmware and software, and may even be implemented as dedicated hardware circuitry.

The run-time library 500 may create an intermediate layer of abstraction between a traditional industry standard API, such as a Portable Operating System Interface (“POSIX”) compliant API, and the hardware of a multi-sequencer system that supports at least a canonical set of shred instructions. The run-time library 500 may act as an intermediate level of abstraction so that a programmer may utilize a traditional thread API (such as, for instance, PTHREADS API or WINDOWS THREADS API or OPENMP API) with hardware that supports shredding. The library 500 may provide functions that transparently invoke the canonical shred instructions, based on user-programmed primitives.

FIG. 6 is a data flow diagram illustrating in further detail that the software library 500 may include a scheduling hints generator 506 that monitors behavior of a shredded program 602, and in particular, monitors thread execution history of the shredded program 602. One of skill in the art will understand that, for at least one embodiment, the shredded program 602 represented in FIG. 6 may be of any format, including source code or object code, such as, for example, binary executable code of COFF format or PE32 format.

The scheduling hints generator 506 also, in addition to monitoring program behavior, may analyze, characterize and record certain aspects of the execution history. For at least one embodiment, these aspects of the execution history may be recorded in the form of either or both of a shred dependency graph 600 and/or a time-stamped shred dependency graph 604.

The shred dependency graph (“SDG”) 600 explicitly represents shredded program execution as a graph of shred dependencies. For at least one embodiment, the SDG 600 may be a directed graph, where each node is a shred and each line is a dependency between two shreds. The SDG 600 thus represents the dependencies among the shred instances that are dynamically executed during an execution pass of the shredded program 602.

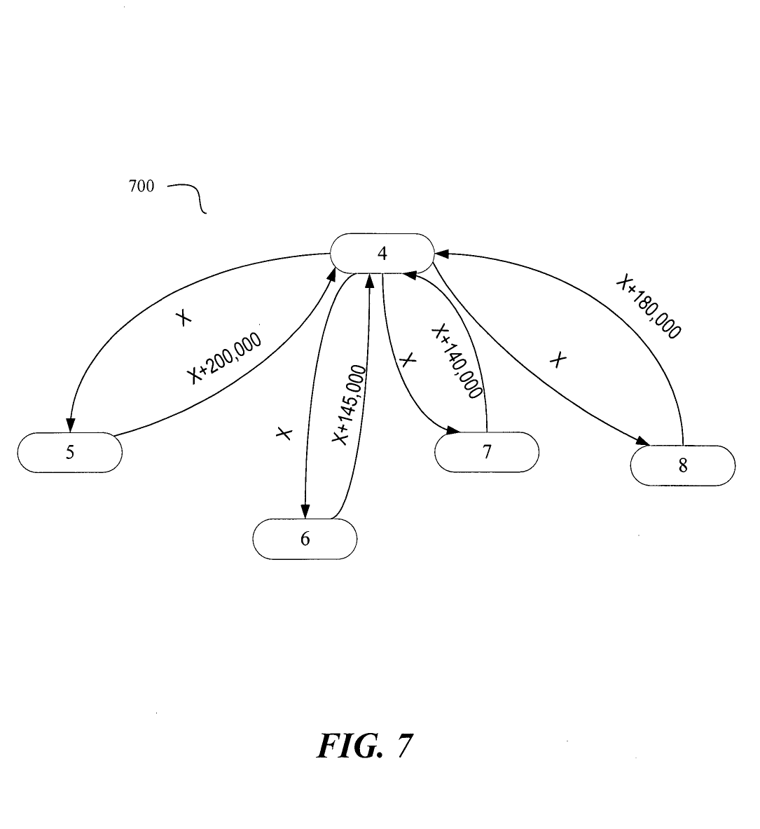

FIG. 7 illustrates a sample shred dependency graph 700. The example SDG 700 shown in FIG. 7 represents a multi-shredded matrix multiplication program running on a system that includes one or more sequencers. In FIG. 7, shred 4 is the main shred, and it forks 4 other shreds (5, 6, 7 and 8) that perform the matrix multiplication in parallel. FIG. 7 shows edges from shred 4 to all other shreds representing the fork operations. For the example shown in FIG. 7, one of skill in the art will recognize that the program could run on a system that includes four sequencers, since the main shred (4) does not perform any work until the forked shreds have completed their work.

The label on each of these four edges shown in FIG. 7 represents the latency, in clock cycles, of shred 4 at the time that each shred was created. The example shown in FIG. 7 assumes a shred join instruction for all of the forked shreds. Accordingly, each of the forked shreds (5, 6, 7 and 8) also includes a return edge. The labels on the return edges represent the execution latencies, in clock cycles, of the respective shreds.

Returning to FIG. 6, the TSDG 604 shown therein further extends the information of a SDG 600 with chronological information about dynamic shred execution. In particular, the TSDG 604 may incorporate a variety of weight metrics relevant to shred scheduling and execution, such as the timing of the shred dependencies. In the TSDG 604, the nodes represent the dynamic instances of scheduled shreds and the edge-labels represent the time at which an event indicating a dependency occurred.

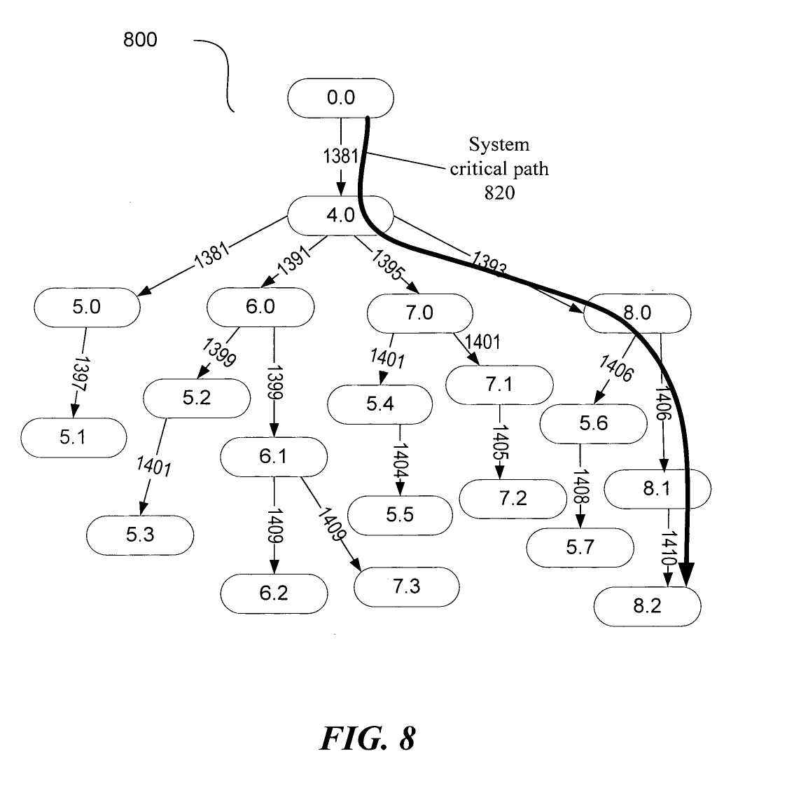

FIG. 8 illustrates an example TSDG 800 for a sample program. The TSDG 800 represents unrolled program execution for multiple dependencies and time stamps the time at which each dependency happens. The scheduler 450 (FIG. 4) may be instrumented to capture dependencies as shreds are scheduled, and this information (see, e.g., 608 of FIG. 6) may be forwarded to the scheduling hints generator (see 506, FIG. 6) and utilized to generate the TSDG 800 in FIG. 8 (see, also, 604 in FIG. 6).

A dependence may be recorded when the scheduler encounters a shred control primitive or instruction such “shred_create”. In addition, a dependence may be recorded when the scheduler encounters a synchronization primitive or instruction such as a mutex, yield, or critical section primitive. That is, a dependence may be defined as an occurrence of one shred being blocked from further execution while waiting for some event to occur on another shred. For example, FIG. 8 illustrates that shred 5 (node 5.4) is blocked on a mutex until shred 7 (node 7.0) releases the mutex at time 1401. The mutex may be acquired or released by a programmer's use of synchronization primitives, such as “lock” and “unlock” primitives. Responsive to failure to acquire a mutex by prior execution of a lock primitive (e.g., by shred 7.0), the sequencer for a contending shred may execute a yield operation, causing the synchronization control mechanism (see, e.g., 504 of FIG. 6) to place a descriptor for the contending shred (e.g., shred 5.4) back into the work queue system (see, e.g., 402 of FIG. 6). As is stated above, the work queue system may include a dedicated queue to maintain descriptors for shreds that are blocked for synchronization purposes.

FIG. 8 illustrates that at least one embodiment of the TSDG 800 may identify the system critical path of the program. The system critical path is the path in the program having the longest latency. Any thread on that path is critical to the performance of the program and should therefore be scheduled with a higher priority, if possible.

It is straightforward to identify which shreds are on the system critical path with the information provided by the TSDG 800. The system critical path 820 may be easily identified by starting at the node of the TSDG 800 that has the largest time value (representing the latest node) and traversing upwards to the root of the TSDG 800. FIG. 8 illustrates that node 8.2 is the latest node and that shreds 4 (node 4.0) and 8 (nodes 8.0, 8.1, 8.2) are on the system critical path 820.

Returning to FIG. 6, it is seen that, based on the information in the SDG 600 and TSDG 604, the scheduling hints generator 506 may perform various types of analyses to generate hints 610 that may be utilized by the scheduler 450. By utilizing information about inter-shred dynamic data dependencies as provided by the TSDG 604, the scheduling hints generator 506 may identify and characterize the system critical path (depth of the critical path graph or subgraph) and thread-level parallelism (width of graph or subgraph) of the shredded application program 602. The scheduler may receive the hints 610 and may use the hints to explore parallelism in order to advance scheduling and to enhance scheduling efficiency by more judiciously scheduling shreds of the program 602.

In addition, if the hints generator 506 utilizes information from the shred synchronization control software 504, such as information related to synchronization objects such as mutex, conditional variables, etc, then the SDG 600 and/or TSDG 604 generated based on such information may also reflect shred data dependencies in addition to shred control dependencies.

The scheduling hints generator 506 may employ any one or more of several optimization approaches that take advantage of the scheduling information 608 about dynamic behavior of inter-shred interactions of the shredded program 602. Any optimization approach that attempts to explore thread-level parallelism may be employed. For example, thread-level analogs may be implemented for many classic instruction-level parallelism (ILP) algorithms that are based on instruction data or control dependency graphs. These algorithms include list scheduling, stochastic scheduling, and tree traversal scheduling. Analogous approaches for thread-level parallelism, based on the SDG and the TSDG, may be employed. For at least one embodiment, the optimization approaches employed by the scheduling hints generator 506 may include one or more of: system critical path scheduling, data flow shred scheduling, and dynamic power throttling.

System Critical Path Scheduling. This optimization approach recognizes that certain nodes of the TSDG 604 are more critical to performance of the application program 602 than are other nodes. When performing the system critical path scheduling optimization, the hints generator 506 identifies the critical path-those nodes whose performance affects overall performance for the program 602. The system critical path through the TSDG 604 has the property that no other path in the program 602 has a longer latency. If these nodes take longer to execute, then overall performance of the program 602 is slowed. The hints generator 506 identifies all shreds on the critical path as “critical shreds” and provides a hint to indicate that the scheduler 450 should schedule such shreds with a higher priority than other, non-critical, shreds.

By using this system critical path information, a shred scheduler 450 may improve performance by prioritizing critical shreds. For a scheduler on a symmetric multi-sequencer system, the optimization may involve simply scheduling critical shreds with a higher priority. For an asymmetric multi-sequencer system, the optimization may, for example, involve scheduling critical shreds on faster and/or more powerful sequencers. In general, the scheduler may utilize system critical path information to reduce latency of the system critical path in order to reduce overall program latency.

Data Flow Scheduling. In contrast to system critical path scheduling, which seeks to improve performance by reducing the latency of the critical path of the system, data flow scheduling seeks to reduce latency for an individual shred. In this approach, the scheduler 450 may seek to schedule to the same sequencer those shreds that share data. One goal of such technique is to improve data locality and therefore to decrease the overall number of cache misses, thereby decreasing execution time for a shred.

As is explained above, the TSDG (see 800, FIG. 8) provides shred dependency information. Specifically, the TSDG identifies potential shred dependencies. The hints generator 506 may pass hints 610 about these dependencies to the scheduler 450. The scheduler 450 may then use this information to schedule data-sharing shreds to the same sequencer at around the same time, if possible. By scheduling data-sharing shreds on the same sequencer, data locality is improved and the latency of the shreds can be reduced, thereby improving overall performance.

Dynamic Power Throttling. Rather than attempting to improve performance, the third optimization approach attempts to reduce energy usage by dynamically controlling a power throttle. This approach may be utilized for an asymmetric multiprocessing system that includes one or more sequencers for which power usage may be down-throttled. When down-throttled, the sequencers may utilize less power, be more energy-efficient, and may have a slower execution time.

As has been stated above, the system critical path can be easily determined from the TSDG and therefore, conversely, the TSDG also identifies the shreds that are not performance-critical. The hints generator 506 may thus pass hints 610 that identify non-critical shreds to the scheduler 450. The scheduler 450 may schedule such non-critical shreds on down-throttled sequencers. For an asymmetric multiprocessing system, the scheduler 450 may control the throttling mechanism and may, therefore, essentially control the behavior of the system. Thus, by using system critical path information provided by the TSDG, hints can be generated and provided to a scheduler, which can reduce overall energy usage by dynamically throttling the asymmetric multiprocessing system.

As an alternative embodiment, an asymmetric multiprocessing system may include sequencers of varying fixed power consumption requirements. That is, one or more sequencers may, rather than having power dynamically throttled, be statically configured at a lower power consumption requirement than one or more other sequencers in the system. For such embodiment, non-performance-critical shreds may be scheduled on the lower-power sequencer(s).

Continuing to consult FIG. 6, one can see that scheduling hints 610 generated by the scheduling hints generator 506 may be forwarded to the scheduler 450. The hints 610 may be utilized by the scheduler 450 during a current execution of the shredded program 602 (referred to herein as “online” analysis”). Alternatively, the hints may be utilized by the scheduler 450 during a subsequent pass of the shredded program 602 (referred to herein as “offline analysis”).

For the former approach (online analysis), only a partial TSDG 604 is generated by the scheduling hints generator 506. Using a partial TSDG 604 that has been generated for a window of execution for the shredded program 602, the scheduling hints generator 506 predicts scheduling priority for shreds as the program 602 continues to run. The hints can be used as a predictor for future execution behavior. The output of the scheduler is a new schedule based on these hints or predictions, with the goal to improve performance.

For the latter approach (offline analysis), a full TSDG 604 may be generated during a first pass through the shredded program 602. Scheduling hints 610 generated by the scheduling hints generator 506, based on the full TSDG 604, may then be forwarded to the scheduler 450 and utilized during a subsequent execution pass of the shredded program 602.

At least one embodiment combines the online and offline analysis approaches for a hybrid approach. For the hybrid approach, offline analysis results in scheduling hints harvested from a prior run and profile; such hints are passed to the scheduler 450. With the offline scheduling hints as input, the scheduler 450 may also dynamically refine, adjust, adapt and update the hints based on dynamic shred scheduling behaviors as observed via online analysis.

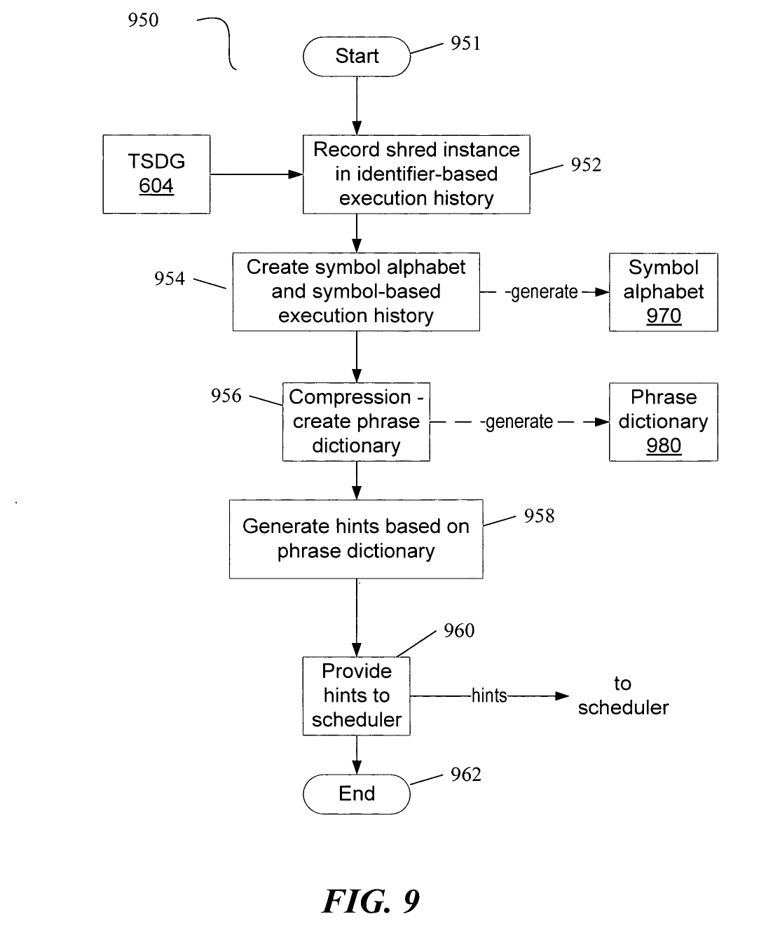

FIG. 9 is a flowchart illustrating at least one embodiment of a method 950 for utilizing the information of the TSDG 604 to perform analysis and generate scheduling hints. For at least one embodiment, the method 950 may be performed by scheduling hints generation logic (see, e.g., 506 of FIG. 6). According to an embodiment of the method 950 shown in FIG. 9, the TSDG 604 is used to form an execution history for the program. Based upon such execution history information, the software in user space (see, e.g., hints generator 506 of runtime library 500 in FIG. 5) may compute inter-shred interaction, deduce inter-shred correlation, and infer heuristics to predict correlated future shreds. Thus, for at least one embodiment, the method 950 shown in FIG. 9 may be performed by a hints generator (e.g., 506 of FIG. 6).

FIG. 9 illustrates that the method 950 begins at block 951 and proceeds to block 952. At block 952, each instance of shred scheduling, as denoted by the TSDG 604, is recorded in an execution history. The instance may be recorded by capturing a shred ID for the scheduling instance. For the entire program execution, the resulting execution history may be a text file of shred ID instances (along with other ancillary information such as timestamp, etc.). From block 952, processing proceeds to block 954.

At block 954, the execution history file “text” may be sorted and an alphabet 970 of unique “symbols” may be generated. Each symbol in the alphabet 970 may be used to represent a unique shred instance. The alphabet 970 may be ranked according to frequency of occurrence for each symbol. In addition, the execution history, based on shred identifiers, recorded at block 952 may be translated into a symbol-based execution history at block 954.

TABLE 1
Sample Shred Instances for a Loop
A
B
C
D
A
B
C
D

As a further example to illustrate the processing of the method 950, assume that a sequence of shred instances is recorded in the execution history at block 952 for a scheduling loop, and translated to symbols at block 954. A sample sequence is set forth in Table 1:

The sample sequence shown in Table 1 indicates that several patterns of recurrent sequences of adjacent symbols may be identified in the symbol-based execution history generated at block 954. For example, Table 1 illustrates that an instance of shred A is always followed by shred B. Thus, AB may be identified as a “phrase.” Such recurrent phrase may be recorded at block 956 in a phrase dictionary 980. Based upon this dictionary 980, a hint may be generated at block 958 to let the scheduler know that shred B is often scheduled after shred A. Upon fturther examination, one can see that the pattern “A, B, C, D” is an even bigger phrase evident in Table 1. Accordingly, the phrase “A, B, C, D” may be recorded in the phrase dictionary 980 at block 956, and a hint about this phrase may be generated at block 958.

The phrases recorded in the phrase dictionary 980 may be identified, for at least one embodiment, by running a compression algorithm at block 956 against the symbol-based execution history that has been generated at block 954. For at least one embodiment, the compression algorithm is an Lempel-Ziv-equivalent compression method for which the alphabet is extended from 8-bit ASCII to a new alphabet represented by the 32-bit or 64-bit symbols in the symbol alphabet 970 that was generated at block 954.

For at least one embodiment, the compression algorithm used at block 956 is proven information-theoretically optimal and efficient (with time linear to the size of the input text and the lookup time close to constant). The result of compression as applied at block 956 may be the phrase dictionary 970, which enumerates the frequently-recurring phrases of symbols that appear in the symbol-based execution history that was generated at block 954. For such embodiment, each phrase in the phrase dictionary 980 represents a recurrent chain of shred scheduling activities involving a particular set of shreds, which may be interacting through a particular set of synchronization objects and/or control primitives in a particular order. The frequency (that is, the amount of redundancy) of each of these recurrent chains may be used to rank the phrases in the phrase dictionary 980.

FIG. 9 illustrates that, after creating the phrase dictionary 980 at block 956, processing of the method 950 proceeds to block 958. At block 958, the dictionary 980 of recurrent phrases may be analyzed. For at least one embodiment, the phrase dictionary 980 is processed at block 958 in descending order (vis-a-vis the ranking imposed at block 956). As a result of this processing, scheduling hints may be generated. For example, based on the recurrent phrases, the hints generator (see, e.g., 506 of FIG. 6) may predict the next one or more upcoming shreds that should be scheduled (for example, shreds B and C should always be scheduled following shred A). Hints may be generated to allow for more efficient scheduling of such shreds. For example, optimization for the aggregate phrase may be performed so that dependent shreds are scheduled on the same or adjacent sequencers (see, e.g., discussion of data flow shred scheduling, above).

To briefly delve a bit deeper into data flow shred scheduling concepts supported by embodiments of the scheduler disclosed herein, one should note that, for at least one embodiment, each processor in a multi-core system includes a cache. It should also be noted that shreds for the same thread may share the same application working set. For example, if shred B depends on shred A, there could be a synchronization point (mutex, etc.) around data that is shared by both shreds. Also, or in the alternative, shreds A and B might touch the same data structure. Generally, if shred B depends on shred A, the scheduler may assume that the shreds share at least some data.

Accordingly, the hints generator may generate a hint, at block 958, to indicate that shreds A and B should be scheduled on the same core, if possible, so that they can share a data cache. In sum, the hints generator may generate a “locality” hint based on linear dependency so that the consumer maybe scheduled to execute close to, or on the same sequencer as, the producer shred. In this manner, the scheduler may effectively move code in order to accommodate data dependencies. Generally stated, the scheduler may attempt to schedule linearly dependent shreds to execute, serially, on the same (or a nearby) sequencer in order to take advantage of data locality at the cache level. This approach is based on the assumption that linearly dependent shreds are likely to use the same data. In other words, the scheduler logic 450 may schedule shreds for execution close to where the working set resides.

Alternatively, the scheduler may utilize a locality hint in order to migrate a working set of data from one cache to another. That is, the scheduler may cause data to be moved to the core on which will execute the code that needs the data. Such approach may be utilized for systems in which the sequencer hardware supports data migration. In other words, the scheduler 450 may schedule data movement towards where the code that uses the data resides.

The scheduler may also take advantage of locality hints to implement a type of shred-level parallelism. If the scheduler receives a hint that shreds A, B, C, and D are linearly dependent and are often executed sequentially as a “phrase”, the scheduler can map the shreds on adjacent sequencers. In addition, the data from each of the sequencers can be migrated along the chain of sequencers so that data is migrated through the dependence chain, although the code for each shred is executed on separate sequencers.

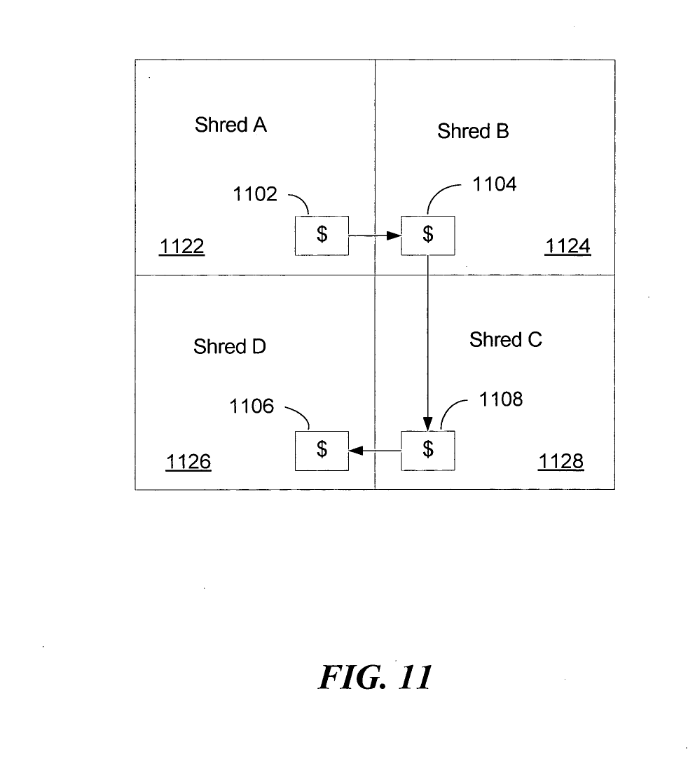

This approach, which may be conceptually viewed as a type of pipelining, is illustrated in FIG. 11. FIG. 11 illustrates that each sequentially-executed shred is scheduled to execute on a separate sequencer. Shred A is scheduled to execute on sequencer 1122; Shred B is scheduled to execute on sequencer 1124; Shred C is scheduled to execute on sequencer 1128; and Shred D is scheduled to execute on sequencer 1126. After shred A is executed, data in the cache 1102 for sequencer 1122 is migrated to the cache 1104 for sequencer 1124 before shred B is executed. Similar data migration is also performed after execution of Shred B, such that data is migrated from cache 1104 to cache 1108 before Shred C is executed on sequencer 1128. Similarly, data is migrated from cache 1108 to cache 1106 before Shred D is executed on sequencer 1126.

Returning to FIG. 9, the hints generated at block 958 maybe further enhanced by knowledge of timing information, such as critical system path information. Utilizing information from the TSDG (see, e.g., 604 of FIG. 6), hints may be generated so that certain phrases are prioritized more highly if they correspond to the system critical path (see discussion of system critical path scheduling, above).

The hints generated at block 958 may also include phrase-level optimizations. For example, runtime software may be aware of hardware resource allocation at any particular point in time (as opposed, for example, to scheduling optimizations performed by a compiler). Accordingly, the scheduling hints generator (see, e.g., 506 of FIG. 6) may thus create hints such that non-dependent shred instances of a phrase on the system critical path are each scheduled on a separate sequencer. Such hints may take into account any symmetry or asymmetry metrics. For example, if shred A of a phrase on the system critical path requires a sequencer with a specific capability but shred B does not, such information may be passed to the scheduler through a hint so that the shreds may be scheduled as efficiently as possible, given available hardware resources at the time of scheduling. Also, for example, the scheduler may, based on such hints, schedule shreds on the critical path for execution on faster or more capable sequencers.

The hints generated at block 958 may also include transformation hints. For at least one embodiment, for example, a transformation hint may be utilized by the scheduler in order to perform load balancing. If the load instruction activity for each shred of a sequential phrase is unequal, but available sequencers on which to execute the shreds are of the same size, then the code for the shreds may be transformed in order to more equally distribute load instructions among the sequencers.

Further discussion of load balancing is made with reference to FIG. 11 again. FIG. 11 illustrates that Shreds A, B, C and D are scheduled to run on sequencers 1122, 1124, 1128, and 1126, respectively. If Shred A includes many more load instructions than shred B, then a hint may be generated such that the scheduler may re-partition shreds A and B so that some of the of later instructions of Shred A are performed as the first instructions executed on sequencer 1124, before the instructions of Shred B are executed on sequencer 1124. In effect, code is moved from one sequencer to another in order to evenly balance the code to match the available hardware resources. Such hints are generated based on dependency information in the TSDG (see, e.g., 604, FIG. 6).

FIG. 9 illustrates that, after the scheduling hints have been provided to the scheduler at block 960, processing for the method 950 then ends at block 962.

Embodiments of the runtime library discussed herein support user-level shreds for any type of multi-sequencer system. Any user-level runtime software that supports user-level threads, including fibers, pthreads and the like, may utilize the techniques described herein. In addition, the scheduling mechanism and techniques discussed herein may be implemented on any multi-sequencer system, including a single-core SMT system (see, e.g., 310 of FIG. 3) and a multi-core system (see, e.g., 350 of FIG. 3). Such multi-sequencer system may include both OS-visible and OS-sequestered sequencers.

For at least one embodiment, user-level shreds from the same application may run on all, or any subset, of OS-visible sequencers and/or OS-sequestered sequencers concurrently. Instead of merely sustaining a one-to-one mapping of application threads to OS threads and relying on the OS to manage the mapping between sequencers and threads, embodiments of the runtime library discussed herein may allow multiple user-level shreds in a single application image to run concurrently in a multi-sequencer system. For a single application program that is both multi-threaded and multi-shredded, embodiments of the present invention may thus support M:N thread-to-shred mapping so that N user-level shreds and M threads may execute concurrently on any or all sequencers in the system, whether OS-visible or OS-sequestered. (M, N≧1).

Such a runtime library as disclosed herein provides a contrast, for example, to systems which allow, at most, only one user-controlled “fiber” to execute per OS-visible thread. A fiber for such systems is associated with an OS-controlled thread, and two fibers from the same thread cannot be executed concurrently. For such contrasted systems, multiple user-level shreds from the same OS-controlled thread cannot execute concurrently.

For at least one embodiment of a runtime library as disclosed herein, the library (see, e.g., 500 of FIG. 5) may initiate one distinct OS thread as a dedicated service thread for each OS-visible sequencer. The service thread can be associated with one or more OS-sequestered sequencers. These OS-visible service threads may each execute an application-specific copy of the self-scheduler (see, e.g., 450 of FIG. 5) for its associated OS-visible sequencer. The service thread may schedule one or more shreds for execution on OS-sequestered sequencers associated with the OS-visible sequencer (see, e.g., shreds 130-132 and 134-136 associated with OS-visible threads 125 and 126, respectively, of FIG. 1). Each of the shreds may run a copy of the self-scheduler on an OS-sequestered sequencer.

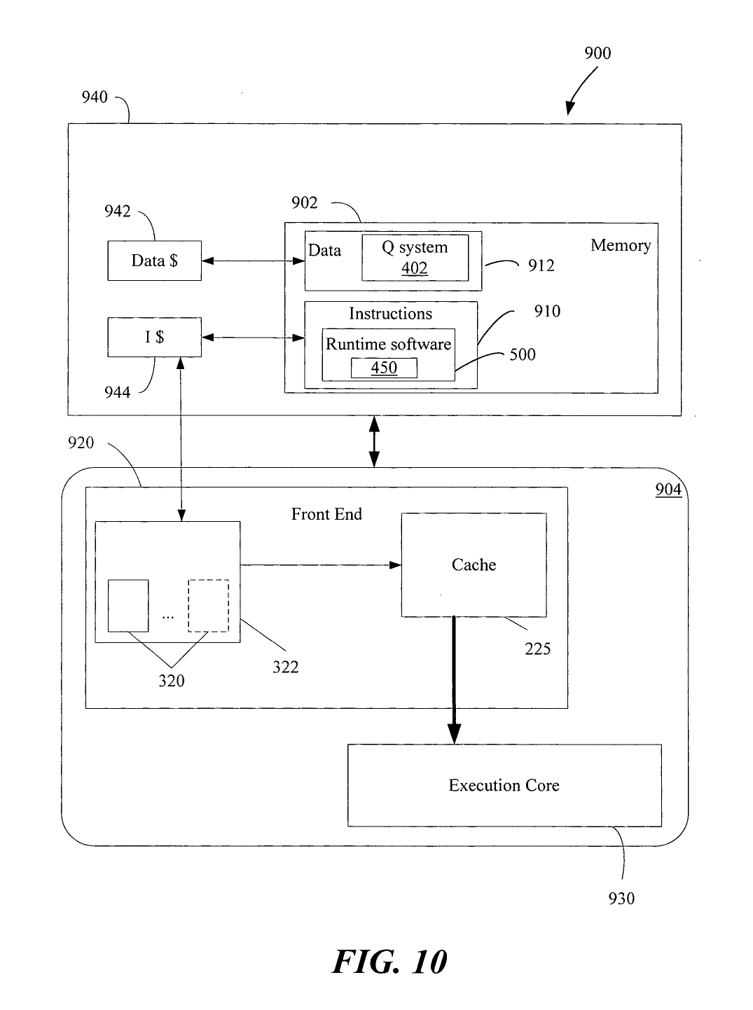

FIG. 10 illustrates at least one sample embodiment of a computing system 900 capable of performing disclosed techniques. The computing system 900 includes at least one processor core 904 and a memory system 940. Memory system 940 may include larger, relatively slower memory storage 902, as well as one or more smaller, relatively fast caches, such as an instruction cache 944 and/or a data cache 942. The memory storage 902 may store instructions 910 and data 912 for controlling the operation of the processor 904. The instructions 910 may include runtime software (see, e.g., 500 of FIG. 5). The data 912 may include a work queue system (see, e.g., 402 of FIGS. 4 and 6).

Memory system 940 is intended as a generalized representation of memory and may include a variety of forms of memory, such as a hard drive, CD-ROM, random access memory (RAM), dynamic random access memory (DRAM), static random access memory (SRAM), flash memory and related circuitry. Memory system 940 may store instructions 910 and/or data 912 represented by data signals that may be executed by processor 904. The instructions 910 and/or data 912 may include code and/or data for performing any or all of the techniques discussed herein. For example, the data 912 may include one or more queues to form a queue system 402 capable of storing shred descriptors as described above. Alternatively, the instructions 910 may include instructions to generate a queue system 402 for storing shred descriptors and may include scheduling logic 450.

The processor 904 may include a front end 920 that supplies instruction information to an execution core 930. Fetched instruction information may be buffered in a cache 225 to await execution by the execution core 930. The front end 920 may supply the instruction information to the execution core 930 in program order. For at least one embodiment, the front end 920 includes a fetch/decode unit 322 that determines the next instruction to be executed. For at least one embodiment of the system 900, the fetch/decode unit 322 may include a single next-instruction-pointer and fetch logic 320. However, in an embodiment where each processor 904 supports multiple thread contexts, the fetch/decode unit 322 implements distinct next-instruction-pointer and fetch logic 320 for each supported thread context. The optional nature of additional next-instruction-pointer and fetch logic 320 in a multiprocessor environment is denoted by dotted lines in FIG. 9.

Embodiments of the methods described herein may be implemented in hardware, hardware emulation software or other software, firmware, or a combination of such implementation approaches. Embodiments of the invention may be implemented for a programmable system comprising at least one processor, a data storage system (including volatile and non-volatile memory and/or storage elements), at least one input device, and at least one output device. For purposes of this application, a processing system includes any system that has a processor, such as, for example; a digital signal processor (DSP), a microcontroller, an application specific integrated circuit (ASIC), or a microprocessor.

A program may be stored on a storage media or device (e.g., hard disk drive, floppy disk drive, read only memory (ROM), CD-ROM device, flash memory device, digital versatile disk (DVD), or other storage device) readable by a general or special purpose programmable processing system. The instructions, accessible to a processor in a processing system, provide for configuring and operating the processing system when the storage media or device is read by the processing system to perform the procedures described herein. Embodiments of the invention may also be considered to be implemented as a machine-readable storage medium, configured for use with a processing system, where the storage medium so configured causes the processing system to operate in a specific and predefined manner to perform the functions described herein.

Sample system 900 is representative of processing systems based on the Pentium®, Pentium® Pro, Pentium® II, Pentium® III, Pentium® 4, Itanium®, and Itanium® 2 microprocessors and the Mobile Intel® Pentium® III Processor—M and Mobile Intel® Pentium® 4 Processor—M available from Intel Corporation, although other systems (including personal computers (PCs) having other microprocessors, engineering workstations, personal digital assistants and other hand-held devices, set-top boxes and the like) may also be used. For one embodiment, sample system may execute a version of the Windows™ operating system available from Microsoft Corporation, although other operating systems and graphical user interfaces, for example, may also be used.

While particular embodiments of the present invention have been shown and described, it will be obvious to those skilled in the art that changes and modifications can be made without departing from the scope of the appended claims. For example, the work queue system 702 may include a single queue that is contended by multiple sequencer types. For such embodiment, resource requirements are expressly included in each shred descriptor. Each sequencer's portion of the distributed scheduler does a check to make sure that the sequencer is capable of executing a shred before the shred's descriptor is removed from the work queue for execution by the sequencer.

Accordingly, one of skill in the art will recognize that changes and modifications can be made without departing from the present invention in its broader aspects. The appended claims are to encompass within their scope all such changes and modifications that fall within the true scope of the present invention.

What is claimed is:

1. A method comprising:
recording dependence information for a plurality of user-level threads of a software program; and
utilizing the dependence information to perform scheduling for the user-level threads, wherein said scheduling for said user-level threads is performed by a scheduler that resides in user space;
wherein said scheduler is to schedule said user-level threads for execution without intervention of an operating system.

2. The method of claim 1, further comprising:
wherein at least two of said plurality of user-level threads share an application image with an OS-controlled thread; and
wherein said scheduler is further to schedule said at least two user-level threads to execute concurrently with each other.

3. The method of claim 1, wherein said recording further comprises:
determining an identifier for a dependent user-level thread responsive to a thread creation instruction in a first user-level thread.

4. The method of claim 3, wherein said recording further comprises:
determining a time stamp associated with creation of the dependent user-level thread.

5. The method of claim 1, wherein said recording further comprises:
determining an identifier for a dependent user-level thread responsive to a synchronization instruction in a first user-level thread.

6. The method of claim 5, wherein said recording further comprises:
determining a time stamp associated with execution of the dependent user-level thread.

7. The method of claim 1, wherein said recording further comprises:
generating a directed graph to represent said dependence information.

8. The method of claim 7, wherein:
said directed graph includes a node for each unique instance of execution for the user-level threads.

9. The method of claim 8, wherein:
each edge between a first and second of said nodes represents a dependence relationship between said first node and said second node.

10. The method of claim 8, wherein:
said directed graph includes a time stamp corresponding to an execution latency for each node.

11. The method of claim 1, wherein said utilizing further comprises:
determining a system critical path that includes one or more of the user-level threads, and
assigning to the user-level threads on the critical path a higher scheduling priority than the remaining user-level threads.

12. The method of claim 1, wherein said utilizing further comprises:
determining a recurring pattern of sequentially-executed user-level threads, and
scheduling the sequentially-executed user-level threads to execute on a single thread execution unit.

13. The method of claim 1, wherein said utilizing further comprises:
determining a system critical path that includes one or more of the user-level threads, and
assigning those of the user-level threads that are not on the system critical path to run on one or more low-power thread execution units.

14. A system, comprising:
a first thread execution unit;
a second thread execution unit; and
scheduler logic to schedule a first user-level thread for execution on said first thread execution unit and to schedule a second user-level thread for concurrent execution on said second execution unit;
wherein said scheduler is to perform said scheduling based on dependence information about said first and second user-level threads and is further to perform said scheduling without intervention of an operating system.

15. The system of claim 14, wherein:
said scheduler is further to base said scheduling on hardware allocation information associated with said first and second thread execution units.

16. The system of claim 14, further comprising:
one or more additional thread execution units on which said scheduler is to schedule one or more additional user-level threads for concurrent execution.

17. The system of claim 14, wherein:
said scheduler is to receive said dependence information during an execution pass of a software program, and is further to dynamically consider said dependence information during said same execution pass.

18. The system of claim 14, wherein:
said scheduler is to receive said dependence information during an execution pass of a software program, and is further to consider said dependence information during a subsequent execution pass of the software program.

19. A multi-sequencer multithreading system comprising:
a memory system;
a first sequencer;
a second sequencer coupled to said first sequencer and to said memory system; and
scheduling logic, stored in user space of the memory system, the scheduling logic including one or more instructions to concurrently schedule one or more user-level threads associated with a single application image, wherein said concurrent scheduling is based on feedback about dependencies among user-level threads.

20. The system of claim 19, wherein:
the scheduling logic further includes logic to place a descriptor for a pending user-level thread into a work queue.

21. The system of claim 19, wherein:
said first sequencer is of a first sequencer type and said second sequencer is of a second sequencer type.

22. The system of claim 19, wherein:
the scheduling logic further includes logic to monitor said feedback during execution of a software program.

23. An article comprising a machine-accessible medium having a plurality of machine accessible instructions, wherein, when the instructions are executed by a processor, the instructions cause the processor to perform a method, comprising:
recording dependence information for a plurality of user-level threads of a software program; and
utilizing the dependence information to perform scheduling for the user-level threads, wherein said scheduling for said user-level threads is performed by a scheduler routine;
wherein said scheduler routine is to schedule said user-level threads for execution without intervention of an operating system.

24. The article of claim 23, wherein:
at least two of said plurality of user-level threads share an application image with an OS-controlled thread; and
said scheduler routine is further to schedule said at least two user-level threads to execute concurrently with each other.

25. The article of claim 23, wherein said instructions that provide for said recording further comprise instructions that provide for, when executed by a processor:
determining an identifier for a dependent user-level thread responsive to a thread creation instruction in a first user-level thread.

26. The article of claim 23, wherein said instructions that provide for said recording further comprise instructions that provide for, when executed by a processor:
determining a time stamp associated with creation of the dependent user-level thread.

27. The article of claim 23, wherein said instructions that provide for said recording further comprise instructions that provide for, when executed by a processor:
generating a directed graph to represent said dependence information.

28. The article of claim 27, wherein:
said directed graph includes a node for each unique instance of execution for the user-level threads.

29. The article of claim 28, wherein:
each edge between a first and second of said nodes represents a dependence relationship between said first node and said second node.

30. The article of claim 28, wherein:
said directed graph includes a time stamp corresponding to an execution latency for each node.

31. The article of claim 23, wherein said instructions that provide for said utilizing further comprise instructions that provide for, when executed by a processor:
determining a system critical path that includes one or more of the user-level threads, and
assigning to the user-level threads on the critical path a higher scheduling priority than the remaining user-level threads.

32. The article of claim 23, wherein said instructions that provide for said utilizing further comprise instructions that provide for, when executed by a processor:
determining a recurring pattern of sequentially-executed user-level threads, and
scheduling the sequentially-executed user-level threads to execute on the same thread execution unit.

33. The article of claim 23, wherein said instructions that provide for said utilizing further comprise instructions that provide for, when executed by a processor:
determining a system critical path that includes one or more of the user-level threads, and
assigning those of the user-level threads that are not on the system critical path to run on one or more low-power thread execution units.
